(19) United States
(12) Patent Application Publication
(10) Pub. No.: US 2026/0191378 A1
(43) Pub. Date: Jul. 9, 2026

(54) CLEANER

(71) Applicant: SAMSUNG ELECTRONICS CO., LTD., Suwon-si (KR)

(72) Inventors: Youngho KO, Suwon-si (KR); Haekang LEE, Suwon-si (KR); Jaeyoul JEONG, Suwon-si (KR); Kyoungwoung KIM, Suwon-si (KR)

(73) Assignee: SAMSUNG ELECTRONICS CO., LTD., Suwon-si (KR)

(21) Appl. No.: 19/369,831

(22) Filed: Oct. 27, 2025

Related U.S. Application Data
(63) Continuation of application No. PCT/KR2025/016054, filed on Oct. 13, 2025.

(30) Foreign Application Priority Data
Jan. 3, 2025 (KR) 10-2025-0001161
Mar. 7, 2025 (KR) 10-2025-0030138

(51) Int. Cl. A47L 9/00; A47L 11/40; B60G 17/015

(52) U.S. Cl. CPC A47L 9/009; A47L 11/4066; A47L 11/4072; B60G 17/0152; B60G 2202/43

(57) ABSTRACT

A cleaner may include: a housing; and a driving device configured to move the housing, the driving device including: a driving wheel module including a driving wheel that is movable relative to the housing in a first direction toward an inside of the housing and in a second direction toward and outside of the housing; a lifting wheel module including a lifting wheel that is movable relative to the housing in the first and second direction; and a moving module operable to: in a first mode, move the lifting wheel in the first direction toward the inside of the housing, and move the driving wheel in the second direction toward the outside of the housing, and in a second mode, move the lifting wheel in the second direction toward the outside of the housing, and move the driving wheel in the first direction toward the inside of the housing.

### CROSS-REFERENCE TO RELATED APPLICATIONS

This is a continuation application, under 35 U.S.C. §111(a), of International Application PCT/KR2025/016054, filed October 13, 2025, which claims priority under 35 U.S.C. §119 to Korean Patent Application No. 10-2025-0001161, filed January 3, 2025 and Korean Patent Application No. 10-2025-0030138, filed March 7, 2025, in the Korean Intellectual Property Office, the disclosures of which are incorporated herein in their entireties by reference.

### TECHNICAL FIELD

The present disclosure relates to a cleaner including a driving wheel.

### BACKGROUND ART

A robot cleaner is a device that automatically cleans a cleaning space by drawing in dirt such as dust accumulated on a floor while moving around the cleaning space without user intervention. The robot cleaner may clean the cleaning space while driving around the cleaning space.

The robot cleaner may include a driving wheel for driving around the cleaning space. The robot cleaner may determine a distance to an obstacle such as furniture, office supplies or walls installed within a cleaning section through a distance sensor. By selectively operating left and right wheel motors of the robot cleaner, the robot cleaner may clean the cleaning section by changing directions on its own.

When an obstacle, which is present in the cleaning section, is higher than a predetermined height, the robot cleaner may not over the obstacle and thus avoid the obstacle. For example, when there is an obstacle with a height higher than a predetermined height within the cleaning section, the robot cleaner may clean a region in which the obstacle is not present, and may avoid a region, in which the obstacle is present, and thus may not clean the region. For example, when a mat with a height higher than a predetermined height is present in a cleaning section, a user can move the robot cleaner over the mat to clean a region in which the mat is present.

### DISCLOSURE

### Technical Problem

The present disclosure is directed to providing a cleaner with improved mobility performance.

Additional aspects of the disclosure will be set forth in part in the description which follows and, in part, will be obvious from the description, or may be learned by practice of the disclosure.

### Technical Solution

In accordance with the present disclosure, a cleaner may include: a housing; and a driving device configured to move the housing, the driving device including: a driving wheel module including a driving wheel that is movable relative to the housing in a first direction toward an inside of the housing and in a second direction toward and outside of the housing; a lifting wheel module including a lifting wheel that is movable relative to the housing in the first direction and the second direction; and a moving module operable to: in a first mode, move the lifting wheel in the first direction toward the inside of the housing, and move the driving wheel in the second direction toward the outside of the housing, and in a second mode, move the lifting wheel in the second direction toward the outside of the housing, and move the driving wheel in the first direction toward the inside of the housing.

The moving module may include: a moving drive source configured to provide power to move the driving wheel and the lifting wheel according to the first mode and the second mode, a first moving gear connected to the moving drive source and configured to apply a force to the lifting wheel module to move the lifting wheel in the first direction and the second direction, and a second moving gear configured to apply a force to the driving wheel module to move the driving wheel in the first direction and the second direction based on the operation of the first moving gear.

The driving wheel module may further include a driving wheel case including a case support portion, and with the moving module operated in the second mode, the case support portion may be supported by the second moving gear.

The lifting wheel module may further include a lifting wheel case including a case gear portion connected to the first moving gear.

The second moving gear may include a pinion gear and a rack gear.

The second moving gear may further include a moving support portion including a curved surface configured to contact a portion of the driving wheel module such that, with the moving module operated in the second mode, the driving wheel may be restricted from moving in the second direction.

The driving device may further include a rotation drive source configured to generate power to rotate the driving wheel and the lifting wheel.

The driving device may further include a power transmission gear to transmit the power generated by the rotation drive source to the lifting wheel module to rotate the lifting wheel.

The lifting wheel module may further include: a lifting wheel gear connected to the power transmission gear so as to receive the power generated by the rotation drive source, and a lifting transmission gear to transmit the power received by the lifting wheel gear to the lifting wheel to rotate the lifting wheel.

The driving wheel module may further include: a driving wheel gear connected to the lifting wheel gear so as to receive the power generated by the rotation drive source, and a driving transmission gear to transmit the power received by the driving wheel gear to the driving wheel to rotate the driving wheel.

The driving device may further include a shaft configured to support the power transmission gear, the lifting wheel gear, and the driving wheel gear such that the power transmission gear, the lifting wheel gear, and the driving wheel gear are rotatable about the shaft, and the lifting wheel module and the driving wheel module are rotatable around the shaft based on the operation of the moving module.

The driving device may further include an elastic body configured to apply an elastic force to the driving wheel module such that, with the moving module operated in the first mode, the driving wheel may be moved in the second direction.

With the moving module operated in the first mode and with a force greater than the elastic force applied to the driving wheel module, the driving wheel may be moved in the first direction.

The driving device may further include a wheel cover on which the driving wheel module and the lifting wheel module are rotatably mounted, and the elastic body may include: a first end connected to the driving wheel module, and a second end opposite the first end, and connected to the wheel cover.

The lifting wheel may be in front of the driving wheel with respect to a driving direction of the housing in which the driving device may be configured to move the housing.

Another aspect of the present disclosure provides a cleaner including: a housing; and a driving device configured to move the housing. The driving device includes: a driving wheel module including a driving wheel movable relative to the housing; a lifting wheel module including a lifting wheel movable relative to the housing; a rotation drive source configured to provide power for rotating the driving wheel and the lifting wheel; and a moving drive source configured to provide power for moving the driving wheel and the lifting wheel.

### DESCRIPTION OF DRAWINGS

FIG. 1 illustrates a front view of a cleaner according to one embodiment of the present disclosure.

FIG. 2 illustrates a rear view of the cleaner according to one embodiment of the present disclosure.

FIG. 3 illustrates a lower portion of the cleaner according to one embodiment of the present disclosure.

FIG. 4 illustrates a driving device of the cleaner according to one embodiment of the present disclosure when viewed from a lower side.

FIG. 5 illustrates the driving device of the cleaner according to one embodiment of the present disclosure when viewed from an upper side.

FIG. 6 is an exploded view of the driving device of the cleaner according to one embodiment of the present disclosure.

FIG. 7 illustrates some components for rotating a driving wheel and a lifting wheel of the driving device of the cleaner according to one embodiment of the present disclosure.

FIG. 8 illustrates some components related to a moving module of the driving device of the cleaner according to one embodiment of the present disclosure.

FIG. 9 illustrates a state of the driving device while the moving module of the driving device of the cleaner according to one embodiment of the present disclosure operates in a first mode.

FIG. 10 illustrates an inside of the driving device while the moving module of the driving device of the cleaner according to one embodiment of the present disclosure operates in the first mode.

FIG. 11 illustrates a state of the driving device while the moving module of the driving device of the cleaner according to one embodiment of the present disclosure operates in a second mode.

FIG. 12 illustrates the inside of the driving device while the moving module of the driving device of the cleaner according to one embodiment of the present disclosure operates in the second mode.

FIG. 13 illustrates a state in which the cleaner according to one embodiment of the present disclosure detects a height of an obstacle.

FIG. 14 illustrates a state in which the cleaner according to one embodiment of the present disclosure approaches an obstacle and lowers a caster.

FIG. 15 illustrates a state in which the caster of the cleaner according to one embodiment of the present disclosure climbs on the obstacle.

FIG. 16 illustrates a state in which the driving wheel of the cleaner according to one embodiment of the present disclosure comes into contact with the obstacle.

FIG. 17 illustrates a state in which the lifting wheel of the cleaner according to one embodiment of the present disclosure is lowered and the driving wheel is raised.

FIG. 18 illustrates a state in which the driving wheel of the cleaner according to one embodiment of the present disclosure is placed on the obstacle.

FIG. 19 illustrates a state in which the lifting wheel of the cleaner according to one embodiment of the present disclosure is raised and the driving wheel is lowered.

FIG. 20 illustrates a control block diagram of the cleaner according to one embodiment of the present disclosure.

### MODE FOR INVENTION

The various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of "and / or" includes a plurality of combinations of relevant items or any one item among a plurality of relevant items.

Herein, the expressions “a first”, “a second”, “the first”, “the second”, etc., may simply be used to distinguish an element from other elements, but is not limited to another aspect (importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms "including", "having", and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

Hereinafter a robot cleaner, which is a type of cleaner, is described as an example, but the configuration of the present disclosure is not limited thereto. For example, the configuration of the present disclosure may be applied to a canister-type cleaner or a stick-type cleaner.

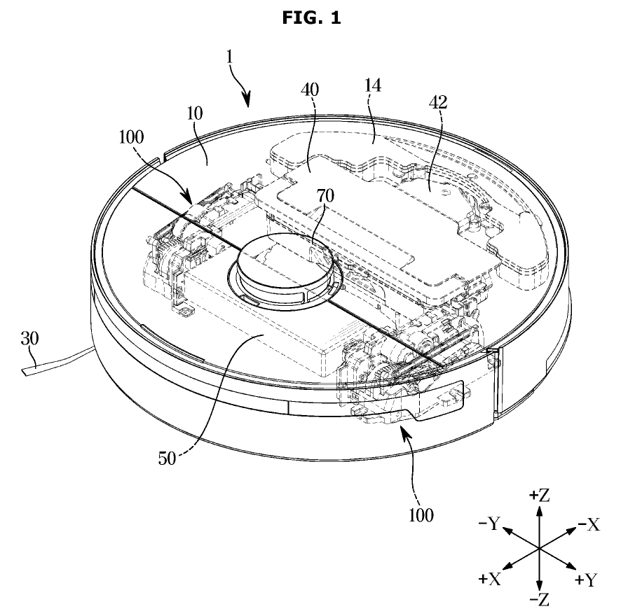

In the following detailed description, the terms of "front", "rear", "left", "right", "upper", "lower", and the like may be defined by the drawings, but the shape and the location of the element is not limited by the term. For example, as illustrated in FIGS. 1 to 3, a direction in which a mop 60 is located from a center of a cleaner 1 may be defined as the rear (-X direction), and the opposite direction thereof may be defined as the front (+X direction).

Hereinafter exemplary embodiments of the present disclosure will be described in detail with reference to the accompanying drawings

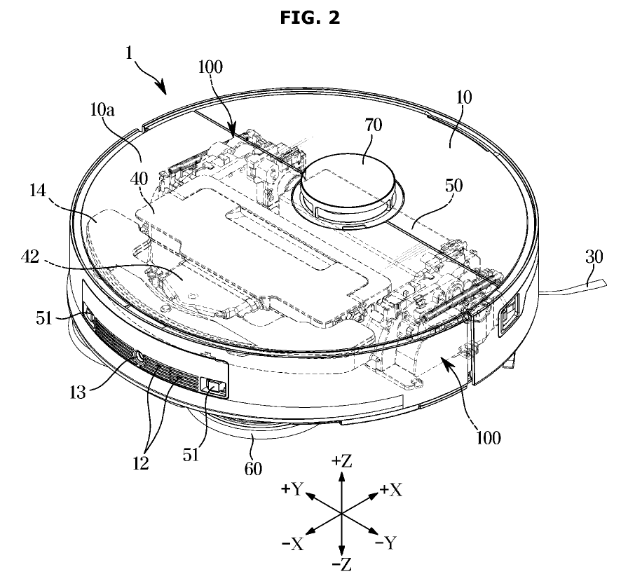

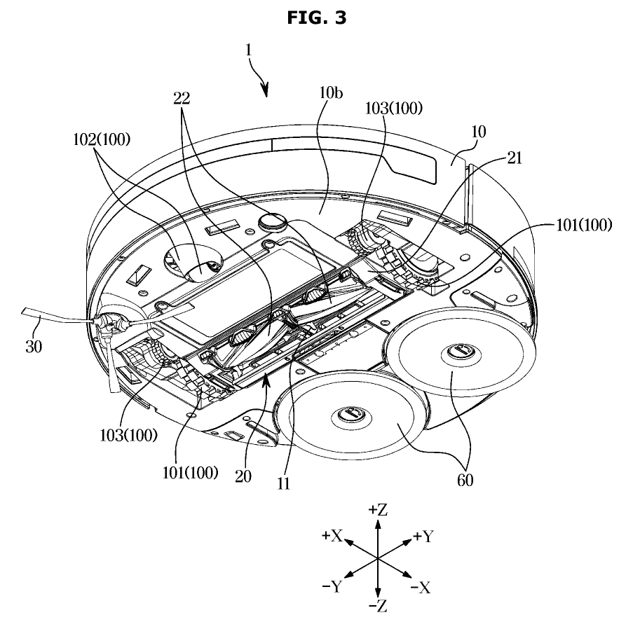

FIG. 1 illustrates a front view of a cleaner according to one embodiment of the present disclosure. FIG. 2 illustrates a rear view of the cleaner according to one embodiment of the present disclosure. FIG. 3 illustrates a lower portion of the cleaner according to one embodiment of the present disclosure.

Referring to FIGS. 1 to 3, the cleaner 1 may include a housing 10. The housing 10 may form an overall appearance of the cleaner 1. Components of the cleaner 1 may be received inside the housing 10. For example, electrical components may be disposed inside the housing 10.

The cleaner 1 may include a suction port 11. The suction port 11 may be formed to face a surface to be cleaned. The suction port 11 may be open toward the surface to be cleaned. For example, the suction port 11 may be formed in the housing 10. The suction port 11 may be formed in a lower portion of the housing 10. The suction port 11 may be formed by penetrating a lower housing 10b of the housing 10. Dirt on the surface to be cleaned may be drawn into an inside of the housing 10 through the suction port 11 together with air.

For example, the cleaner 1 may include a brush 30. The brush 30 may strike a surface to be cleaned to scatter dirt. Dirt scattered by the brush 30 may be introduced into the suction port 11 together with air.

For example, the cleaner 1 may include the brush 30 disposed adjacent to a lower edge of the housing 10. The brush 30 may guide dirt around the housing 10 to the suction port 11. The brush 30 may be rotatably mounted relative to the housing 10. A rotation axis of the brush 30 may be an axis extending approximately along a vertical direction (Z direction). The brush 30 may be referred to as a side brush 30.

The cleaner 1 may include a dust collector 40. Dirt and/or air drawn in through the suction port 11 may be moved to the dust collector 40. Dirt drawn in through the suction port 11 may be collected in the dust collector 40. Air drawn in through the suction port 11 may be filtered as the air passes through the dust collector 40. Dirt and air drawn in through the suction port 11 may be separated in the dust collector 40.

The cleaner 10 may include a discharge port 12. The discharge port 12 may be formed in the housing 10. The discharge port 12 may be formed on a rear side of the housing 10. Air drawn in through the suction port 11 may be filtered and discharged to the outside of the cleaner 1 through the discharge port 12. For example, a plurality of discharge ports 12 may be provided, and the plurality of discharge ports 12 may be provided with a plurality of holes.

The cleaner 1 may include a suction motor 42. The suction motor 42 may generate a suction force. By the suction force generated by the suction motor 42, the suction port 11 may draw in dirt and/or air. By the suction force generated by the suction motor 42, the discharge port 12 may discharge air, which is drawn to the inside of the cleaner 1 and filtered, to the outside. The suction motor 42 may be arranged on an air path formed between the suction port 11 and the discharge port 12.

The cleaner 1 may include a battery 50. The battery 50 may be configured to be rechargeable. The battery 50 may provide power required to operate the cleaner 1.

The cleaner 1 may include a charging terminal 51. The charging terminal 51 may be electrically connected to the battery 50. For example, while the cleaner 1 is docked to a station, the charging terminal 51 of the cleaner 1 may be electrically connected to a charging terminal of the station. As the charging terminal 51 of the cleaner 1 is electrically connected to the charging terminal of the station, the battery 50 of the cleaner 1 may be charged. That is, while the cleaner 1 is docked to the station, the battery 50 may be charged.

The cleaner 1 may include the mop 60. The mop 60 is detachably mountable to the lower portion of the housing 10. The mop 60 may be rotatably mounted relative to the housing 10. The mop 60 may be provided to come into contact with a surface to be cleaned and clean the surface to be cleaned. The mop 60 may wipe away dirt from the surface to be cleaned while the mop 60 is wet. In the drawing, it is illustrated that two mops 60 are provided, but there is no limitation on the number of mops 60. The mop 60 may be referred to as a cleaning pad 60. The mop 60 may be referred to as a wet pad 60.

The mop 60 may be supplied with moisture from a water tank (not shown) of the cleaner 1. For example, when a moisture content of the mop 60 decreases while the cleaner 1 is cleaning, the water stored in the water tank may be supplied to the mop 60.

The cleaner 1 may include a water replenishing portion 13. The water replenishing portion 13 may be formed in the housing 10. The water replenishing portion 13 may be formed on the rear side of the housing 10. For example, while the cleaner 1 is docked to the station, the water replenishing portion 13 may receive water provided from the station. The water supplied to the cleaner 1 through the water replenishing portion13 may be stored in the water tank. While the cleaner 1 is docked to the station, the water replenishing portion 13 of the cleaner 1 may be docked to a water supply portion of the station.

The cleaner 1 may include an obstacle sensor 70. For example, the obstacle sensor 70 may be configured to detect a position of an obstacle or a distance to the obstacle. The obstacle sensor 70 may be mounted on the housing 10. For example, the obstacle sensor 70 may protrude from an upper housing 10a of the housing 10.

The cleaner 1 may include a drum module 20 arranged in the suction port 11. The drum module 20 may strike a surface to be cleaned to scatter dirt. The dirt scattered by the drum module 20 may be introduced into the suction port 11 together with the air. For example, the drum module 20 may include a drum case 21, and a drum 22 rotatably mounted on the drum case 21.

The cleaner 1 may include a driving device 100 for driving of the cleaner 1. The driving device 100 may be mounted on the housing 10 and may move the housing 10. For example, the driving device 100 may include a pair of driving wheels 101. For example, the driving device 100 may further include at least one caster 102 for stable driving of the cleaner 1.

The driving device 100 may be configured to move the housing 10. For example, the driving device 100 may be disposed on the left and right sides of the housing 10, respectively. By selectively operating the driving devices 100 provided on the left and right sides of the housing 10, the cleaner 1 may move forward, backward, left, or right.

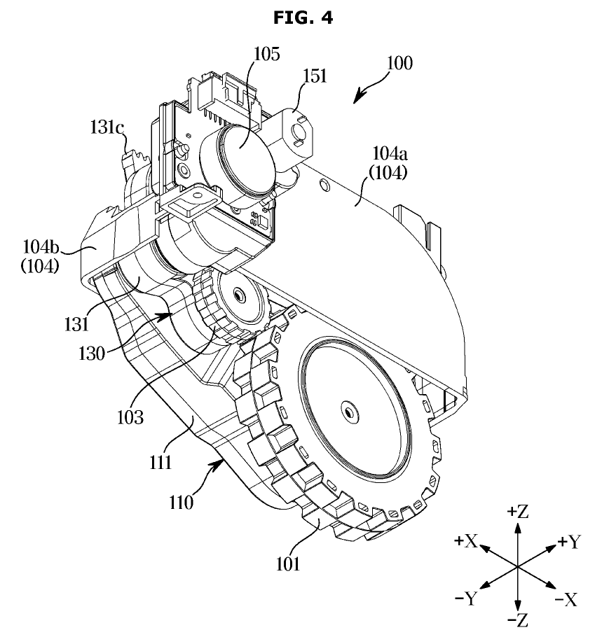

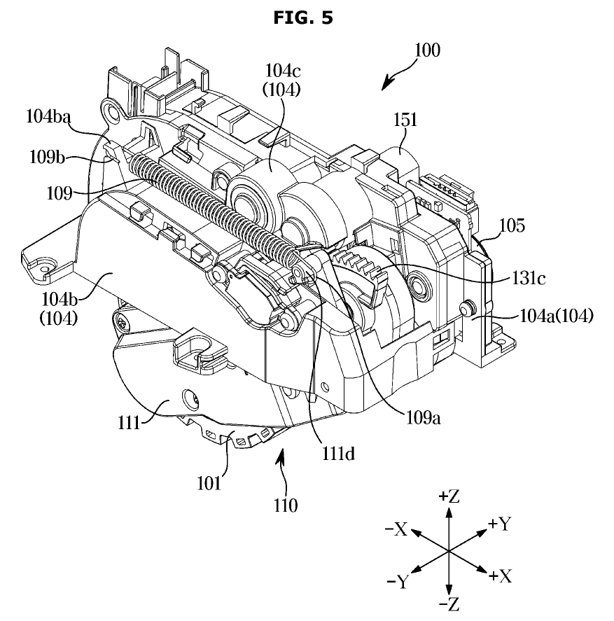

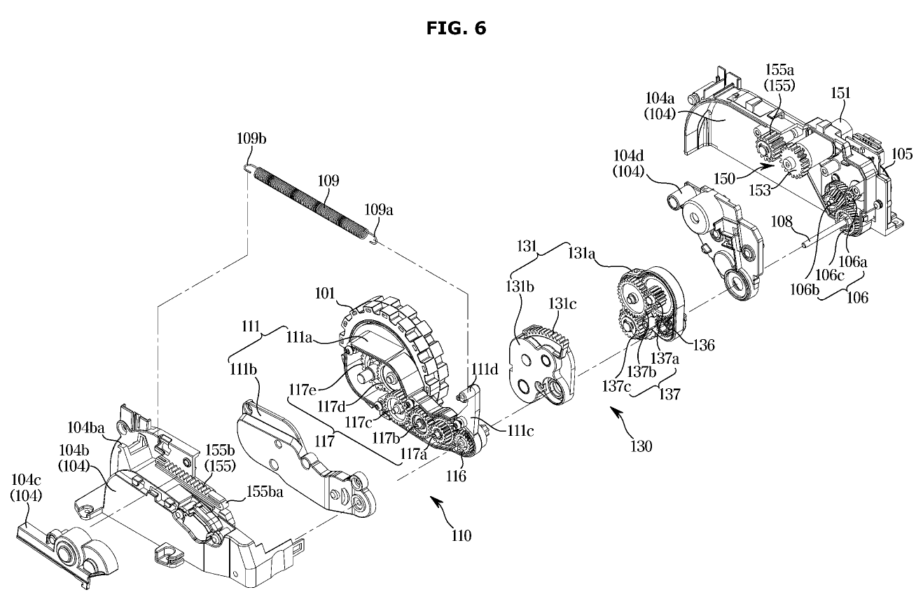

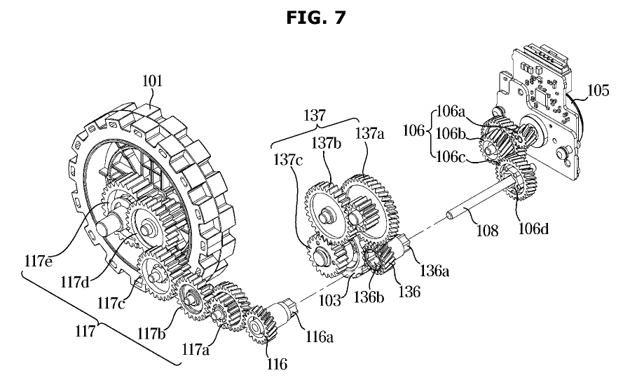

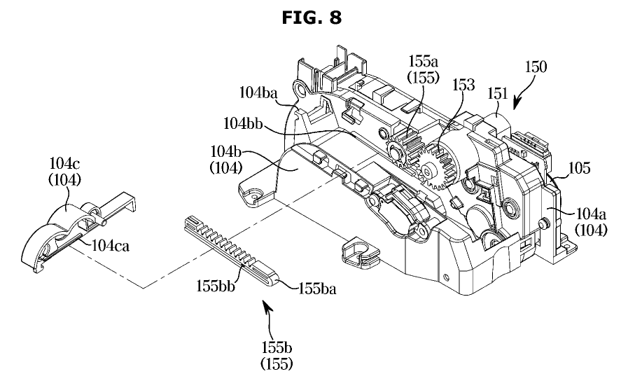

FIG. 4 illustrates a driving device of the cleaner according to one embodiment of the present disclosure when viewed from a lower side. FIG. 5 illustrates the driving device of the cleaner according to one embodiment of the present disclosure when viewed from an upper side. FIG. 6 is an exploded view of the driving device of the cleaner according to one embodiment of the present disclosure. FIG. 7 illustrates some components for rotating a driving wheel and a lifting wheel of the driving device of the cleaner according to one embodiment of the present disclosure. FIG. 8 illustrates some components related to a moving module of the driving device of the cleaner according to one embodiment of the present disclosure.

Referring to FIGS. 4 to 8, the driving device 100 according to one embodiment of the present disclosure may include a wheel cover 104. The wheel cover 104 may be mounted on the housing 10. The wheel cover 104 may be provided to form a space for receiving components of the driving device 100. The wheel cover 104 may be configured to allow components of the driving device 100 to be mounted thereon.

For example, the wheel cover 104 may support a driving wheel module 110. The wheel cover 104 may support a lifting wheel module 130. The driving wheel module 110 and the lifting wheel module 130 may be rotatably mounted on the wheel cover 104. A moving module 150 may be mounted on the wheel cover 104.

For example, the wheel cover 104 may include a first wheel cover 104a, a second wheel cover 104b, a third wheel cover 104c, and a fourth wheel cover 104d. The second wheel cover 104b may be detachably mounted to the first wheel cover 104a. The third wheel cover 104c may be detachably mounted to the second wheel cover 104b. The fourth wheel cover 104d may be detachably mounted to the first wheel cover 104a. The third wheel cover 104c may be configured to cover the moving module 150. The fourth wheel cover 104d may be configured to cover a power transmission gear 106. For example, at least a portion of the wheel cover 104 may be formed integrally.

The driving device 100 may include a shaft 108 for rotatably supporting the driving wheel module 110 and the lifting wheel module 130. For example, the shaft 108 may rotatably support the power transmission gear 106, a lifting wheel gear 136, and a driving wheel gear 116. The shaft 108 may be coupled to the wheel cover 104. The lifting wheel module 130 may be rotatable about the shaft 108 based on the operation of the moving module 150. The driving wheel module 110 may be rotatable about the shaft 108 based on the operation of the moving module 150.

The driving device 100 may include a rotation drive source 105 configured to provide power for rotating the driving wheel 101 and a lifting wheel 103. For example, the rotation drive source 105 may include a motor. The rotation drive source 105 may be mounted on the wheel cover 104. For example, the rotation drive source 105 may be mounted on the first wheel cover 104a. The rotation drive source 105 may be connected to the power transmission gear 106.

The driving device 100 may include the power transmission gear 106 for transmitting power generated from the rotation drive source 105 to the lifting wheel module 130. The power transmission gear 106 may be connected to the lifting wheel module 130. For example, the power transmission gear 106 may include a first power transmission gear 106a, a second power transmission gear 106b, and a third power transmission gear 106c. For example, the first power transmission gear 106a may be connected to the rotation drive source 105, the second power transmission gear 106b may be connected to the first power transmission gear 106a, and the third power transmission gear 106c may be connected to the second power transmission gear 106b. For example, the third power transmission gear 106c may be connected to the lifting wheel gear 136 of the lifting wheel module 130. The third power transmission gear 106c may be rotatably coupled to the shaft 108. As an example, some components of the power transmission gear 106 may be omitted.

The power transmission gear 106 may include a transmission gear connection portion 106d for connection with the lifting wheel module 130. For example, the transmission gear connection portion 106d may be connected to a lifting gear connection portion 136a provided on the lifting wheel gear 136. For example, the transmission gear connection portion 106d may have a groove shape, and the lifting gear connection portion 136a may have a protrusion shape that may be inserted into the transmission gear connection portion 106d. When the transmission gear connection portion 106d and the lifting gear connection portion 136a are connected, the power transmission gear 106 and the lifting wheel gear 136 may be configured to rotate together. For example, in order to transmit a rotational force of the power transmission gear 106 to the lifting wheel gear 136, a shape of a cross-section of the transmission gear connection portion 106d and the lifting gear connection portion 136a that is perpendicular to the shaft 108 may have a shape in which a distance from the shaft 108 changes, such as an ellipse or a polygon, rather than a circle.

The driving device 100 may include the driving wheel module 110. The driving wheel module 110 may be configured to be rotatable relative to the housing 10. The driving wheel module 110 may be rotatably mounted on the wheel cover 104.

The driving wheel module 110 may include the driving wheel 101. The driving wheel 101 may be movable relative to the housing 10. The driving wheel 101 may move in a direction toward the outside of the housing 10 or in a direction toward the inside of the housing 10 as the driving wheel module 110 rotates relative to the wheel cover 104. The driving wheel 101 may be movable relative to the wheel cover 104.

The driving wheel module 110 may include a driving wheel case 111. The driving wheel 101 may be configured to be rotatable relative to the driving wheel case 111. The driving wheel case 111 may form a space for receiving at least a portion of the components of the driving wheel module 110. The driving wheel case 111 may be rotatably mounted on the shaft 108.

For example, the driving wheel case 111 may include a first driving wheel case 111a, and a second driving wheel case 111b. The second driving wheel case 111b may be detachably mounted to the first driving wheel case 111a. For example, the driving wheel case 111 may be formed integrally.

The driving wheel module 110 may include the driving wheel gear 116. The driving wheel gear 116 may be connected to the lifting wheel module 130 to receive power generated from the rotation drive source 105. For example, the driving wheel gear 116 may be connected to the lifting wheel gear 136 of the lifting wheel module 130. The driving wheel gear 116 may receive power generated from the rotation drive source 105 through the power transmission gear 106 and the lifting wheel gear 136. The driving wheel gear 116 may be rotatably coupled to the shaft 108.

The driving wheel gear 116 may include a driving gear connection portion 116a to be coupled to the lifting wheel gear 136 of the lifting wheel module 130. The driving gear connection portion 116a may be connected to a power transmission connection portion 136b provided on the lifting wheel gear 136. For example, the power transmission connection portion 136b may have a groove shape, and the driving gear connection portion 116a may have a protrusion shape that may be inserted into the power transmission connection portion 136b. When the power transmission connection portion 136b and the driving gear connection portion 116a are connected, the lifting wheel gear 136 and the driving wheel gear 116 may be configured to rotate together. For example, in order to transmit the rotational power of the lifting wheel gear 136 to the driving wheel gear 116, a shape of a cross-section of the power transmission connection 136b and the driving gear connection 116a that is perpendicular to the shaft 108 may have a shape in which a distance from the shaft 108 changes, such as an ellipse or polygon, rather than a circle.

The driving wheel module 110 may include a driving transmission gear 117. The driving transmission gear 117 may be configured to transmit power received by the driving wheel gear 116 to the driving wheel 101. The driving transmission gear 117 may be connected to the driving wheel 101. For example, the driving transmission gear 117 may include a first driving transmission gear 117a, a second driving transmission gear 117b, a third driving transmission gear 117c, a fourth driving transmission gear 117d, and a fifth driving transmission gear 117e. For example, the first driving transmission gear 117a may be connected to the driving wheel gear 116, the second driving transmission gear 117b may be connected to the first driving transmission gear 117a, the third driving transmission gear 117c may be connected to the second driving transmission gear 117b, the fourth driving transmission gear 117d may be connected to the third driving transmission gear 117c, and the fifth driving transmission gear 117e may be connected to the fourth driving transmission gear 117d. For example, the fifth driving transmission gear 117e may be connected to the driving wheel 101. As an example, some components of the driving transmission gear 117 may be omitted.

The driving device 100 may include an elastic body 109 for applying an elastic force to the driving wheel module 110 to allow the driving wheel 101 to move toward the outside of the housing 10. For example, the elastic body 109 may apply an elastic force to the driving wheel module 110 to allow the driving wheel 101 to move toward the outside of the housing 10 while the moving module 150 operates in a first mode to move the lifting wheel 103 toward the inside of the housing 10 and to move the driving wheel 101 toward the outside of the housing 10. For example, the elastic body 109 may include a spring.

In the elastic body 109, a first end 109a may be connected to the driving wheel module 110, and a second end 109b opposite to the first end 109a may be connected to the wheel cover 104. For example, in the elastic body 109, the first end 109a may be connected to an elastic body connection portion 111d provided in the driving wheel case 111 of the driving wheel module 110. For example, in the elastic body 109, the second end 109b may be fixed to an elastic body fixing portion 104ba provided in the wheel case 104. The elastic body 109 may be contracted or stretched while a position of the first end 109a connected to the elastic body connection portion 111d of the driving wheel module 110 is changed in a state in which a position of the second end 109b fixed to the elastic body fixing portion 104ba of the wheel cover 104 fixed to the housing 10 is fixed.

The elastic body 109 may be provided to mitigate an impact caused by an obstacle protruding from a floor while the cleaner 1 is driving. For example, when the cleaner 1 climbs over an obstacle protruding from a floor, the driving wheel 101 may be raised along the obstacle by the elastic body 109, and after the cleaner 1 climbs over the obstacle, the cleaner 1 may be lowered to come into contact with the floor due to an elastic force of the elastic body 109.

The driving wheel 101 may be movable toward the inside of the housing 10 based on a force, which is greater than the force applied by the elastic body 109, being applied to the driving wheel module 110 while the moving module 150 operates in the first mode. For example, when a user holds the cleaner 1 away from the floor, the driving wheel module 110 may be moved toward the outside of the housing 10 by the elastic force applied by the elastic body 109. For example, when the cleaner 1 is placed on the floor, the driving wheel module 110 may receive a load of the cleaner 1, which is in a direction opposite to the elastic force applied by the elastic body 109, so as to allow the driving wheel 101 to be moved toward the inside of the housing 10 to a predetermined position.

The driving device 100 may include the lifting wheel module 130. The lifting wheel module 130 may be configured to be rotatable relative to the housing 10. The lifting wheel module 130 may be rotatably mounted on the wheel cover 104.

The lifting wheel module 130 may include the lifting wheel 103. The lifting wheel 103 may be movable relative to the housing 10. The lifting wheel 103 may move in a direction toward the outside of the housing 10 or in a direction toward the inside of the housing 10 as the lifting wheel module 130 rotates relative to the wheel cover 104. The lifting wheel 103 may be movable relative to the wheel cover 104. For example, the lifting wheel 103 may be positioned in front of the driving wheel 101 with respect to a driving direction of the housing 10.

The lifting wheel module 130 may include a lifting wheel case 131. The lifting wheel 103 may be configured to be rotatable relative to the lifting wheel case 131. The lifting wheel case 131 may form a space for receiving at least a portion of the components of the lifting wheel module 130. The lifting wheel case 131 may be rotatably mounted on the shaft 108.

For example, the lifting wheel case 131 may include a first lifting wheel case 131a, and a second lifting wheel case 131b. The second lifting wheel case 131b may be detachably mounted to the first lifting wheel case 131a. For example, the lifting wheel case 131 may be formed integrally.

The lifting wheel case 131 may include a case gear portion 131c. The case gear portion 131c may be configured to receive power generated from a moving drive source 151 of the moving module 150. For example, the case gear portion 131c may be connected to a first moving gear 153 of the moving module 150. Through the case gear portion 131c, the lifting wheel module 130 may receive power from the moving module 150.

The lifting wheel module 130 may include the lifting wheel gear 136. The lifting wheel gear 136 may be connected to the power transmission gear 106 to receive power generated from the rotation drive source 105. The lifting wheel gear 136 may receive power generated from the rotation drive source 105 through the power transmission gear 106. The lifting wheel gear 136 may be rotatably coupled to the shaft 108.

The lifting wheel gear 136 may include the lifting gear connection portion 136a for connection with the power transmission gear 106. The lifting wheel gear 136 may include the power transmission connection portion 136b for connection with the driving gear connection portion 116a of the driving wheel gear 116. The lifting gear connection portion 136a may be disposed on one side of the lifting wheel gear 136 facing the power transmission gear 106, and the power transmission connection portion 136b may be disposed on the other side of the lifting wheel gear 136 facing the driving wheel gear 116.

The lifting wheel module 130 may include a lifting transmission gear 137. The lifting transmission gear 137 may be configured to transmit power received by the lifting wheel gear 136 to the lifting wheel 103. The lifting transmission gear 137 may be connected to the lifting wheel 103. For example, the lifting transmission gear 137 may include a first lifting transmission gear 137a, a second lifting transmission gear 137b, and a third lifting transmission gear 137c. For example, the first lifting transmission gear 137a may be connected to the lifting wheel gear 136, the second lifting transmission gear 137b may be connected to the first lifting transmission gear 137a, and the third lifting transmission gear 137c may be connected to the second lifting transmission gear 137b. For example, the third lifting transmission gear 137c may be connected to the lifting wheel 103. As an example, some components of the lifting transmission gear 137 may be omitted.

The driving device 100 may include the moving module 150. The moving module 150 may be operable in the first mode to move the lifting wheel 103 toward the inside of the housing 10 and to move the driving wheel 101 toward the outside of the housing 10. The moving module 150 may be operable in a second mode to move the lifting wheel 103 toward the outside of the housing 10 and to move the driving wheel 101 toward the inside of the housing 10.

The moving module 150 may include the moving drive source 151. The moving drive source 151 may be configured to provide power for moving the driving wheel 101 and the lifting wheel 103. The moving drive source 151 may be mounted on the wheel cover 104. The moving drive source 151 may be configured to provide power for rotating the driving wheel module 110 and the lifting wheel module 130. For example, the moving drive source 151 may include a motor.

The moving module 150 may include the first moving gear 153. The first moving gear 153 may be connected to the moving drive source 151. The first moving gear 153 may be configured to apply a force to the lifting wheel module 130 to move the lifting wheel 103. The first moving gear 153 may be connected to the lifting wheel module 130. The first moving gear 153 may be engaged with the case gear portion 131c of the lifting wheel module 130.

The moving module 150 may include a second moving gear 155. The second moving gear 155 may be connected to the first moving gear 153. The second moving gear 155 may be configured to apply a force to the driving wheel module 110 to move the driving wheel 101 based on the operation of the first moving gear 153.

For example, the second moving gear 155 may include a pinion gear 155a and a rack gear 155b. For example, the pinion gear 155a may be engaged with the first moving gear 153. The rack gear 155b may be configured to move linearly based on the rotation of the pinion gear 155a.

The rack gear 155b may be slidably coupled to the wheel cover 104. The wheel cover 104 may include rack gear guides 104ca and 104bb for guiding the sliding movement of the rack gear 155b. For example, the rack gear guides 104ca and 104bb may include a first rack gear guide 104ca provided on the third wheel cover 104c, and a first rack gear guide 104bb provided on the second wheel cover 104b.

For example, the rack gear 155b may be provided with gear guides 155bb disposed on one side and on the other side opposite to the one side, and the rack gear guides 104ca and 104bb of the wheel cover 104 may be coupled to the gear guide 155b. For example, the gear guide 155bb of the rack gear 155b may have a groove shape, and the rack gear guides 104ca and 104bb of the wheel cover 104 may include a protruding portion that may be slidably inserted into the gear guide 155bb of the rack gear 155b.

The second moving gear 155 may include a moving support portion 155ba provided to support the driving wheel module 110 to restrict the driving wheel 101 from moving outward of the housing 10 while the moving module 150 operates in the second mode. For example, the moving support portion 155ba may be disposed at one end of the rack gear 155b. The moving support portion 155ba may be provided to be contactable to a case support portion 111c provided in the driving wheel case 111 of the driving wheel module 110 based on the operation of the second moving gear 155.

For example, the moving support portion 155ba may include a curved surface that may come into contact with a portion of the driving wheel module 110. The moving support portion 155ba may include a curved surface formed on a portion that supports the driving wheel module 110. By the curved surface formed on the moving support portion 155ba, the second moving gear 155 may maintain contact with the driving wheel module 110 and stably support the driving wheel module 110 while the driving wheel module 110 rotates around the shaft 108.

The driving wheel case 111 may include the case support portion 111c. The case support portion 111c may be supported by the second moving gear 155 of the moving module 150 while the moving module 150 operates in the second mode to move the lifting wheel 103 toward the outside of the housing 10 and to move the driving wheel 101 toward the inside of the housing 10. The case support portion 111c may come into contact with the moving support portion 155ba of the second moving gear 155.

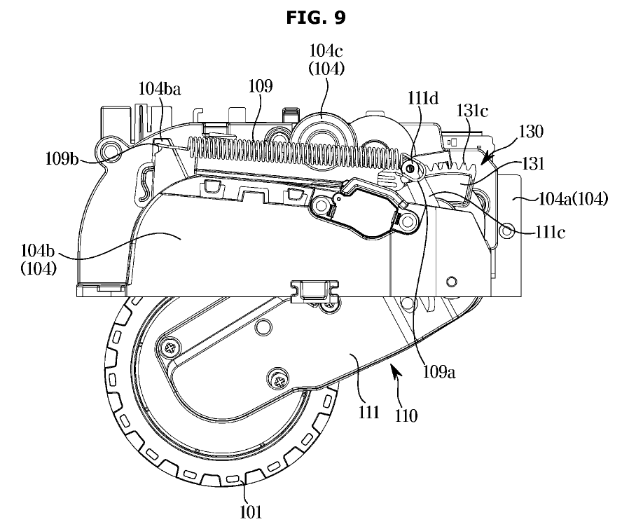

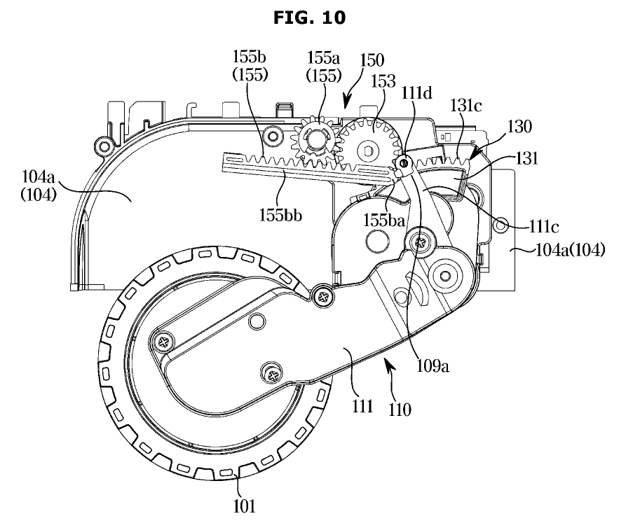

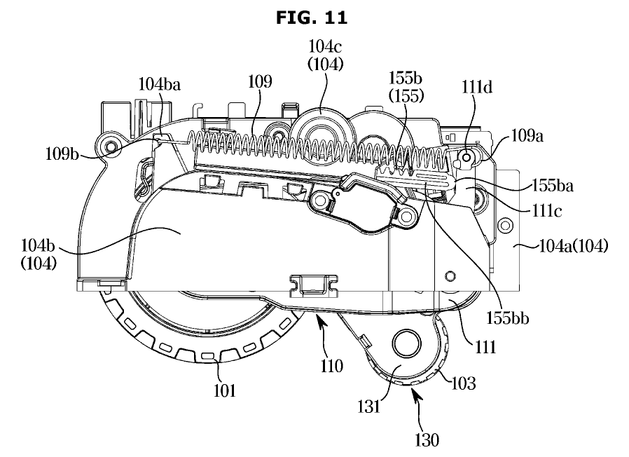

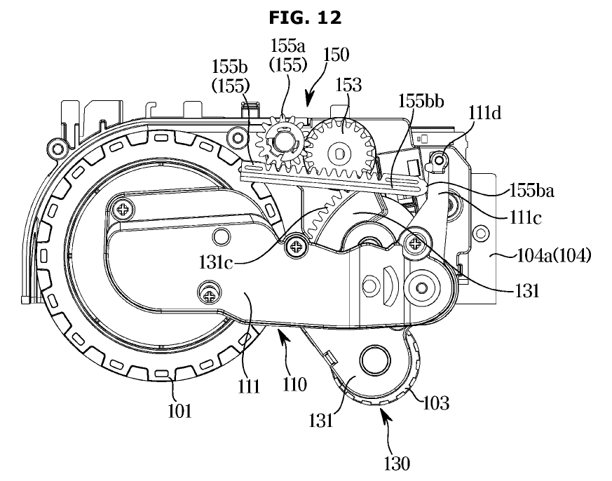

FIG. 9 illustrates a state of the driving device while the moving module of the driving device of the cleaner according to one embodiment of the present disclosure operates in a first mode. FIG. 10 illustrates an inside of the driving device while the moving module of the driving device of the cleaner according to one embodiment of the present disclosure operates in the first mode. FIG. 11 illustrates a state of the driving device while the moving module of the driving device of the cleaner according to one embodiment of the present disclosure operates in a second mode. FIG. 12 illustrates the inside of the driving device while the moving module of the driving device of the cleaner according to one embodiment of the present disclosure operates in the second mode.

An operation of the driving device 100 of the cleaner 1 according to one embodiment of the present disclosure will be described with reference to FIGS. 9 to 12.

Referring to FIGS. 9 and 10, the moving module 150 of the driving device 100 may operate in the first mode to move the driving wheel 101 to the outside of the housing 10 and to move the lifting wheel 103 to the inside of the housing 10. For example, while the moving module 150 operates in the first mode, the driving wheel 101 may be lowered and the lifting wheel 103 may be raised.

While the moving module 150 operates in the first mode, the driving wheel module 110 may receive an elastic force from the elastic body 109 to allow the driving wheel 101 to move toward the outside of the housing 10. For example, while the moving module 150 operates in the first mode, the elastic body 109 may be contracted.

While the moving module 150 operates in the first mode, the second moving gear 155 may be positioned so as not to interfere with the movement of the driving wheel module 110 to allow the driving wheel 101 to move toward the inside of the housing 10. For example, when a force, which is greater than a force applied by the elastic body 109, is applied to the driving wheel module 110, the elastic body 109 may be tensioned. As the elastic body 109 is tensioned, the driving wheel module 110 may rotate with respect to the wheel cover 104 to allow the driving wheel 101 to move toward the inside of the housing 10.

For example, while the moving module 150 operates in the first mode, the second moving gear 155 may support the driving wheel module 110 to allow the driving wheel 101 to move outward from the housing 10 by a predetermined distance.

The cleaner 1 according to one embodiment of the present disclosure may limit a range in which the driving wheel module 110 rotates relative to the wheel cover 104 by the moving module 150 and the elastic body 109 of the driving device 100.

Referring to FIGS. 11 and 12, the moving module 150 of the driving device 100 may operate in the second mode to move the driving wheel 101 toward the inside of the housing 10 and to move the lifting wheel 103 toward the outside of the housing 10. For example, while the moving module 150 operates in the second mode, the driving wheel 101 may be raised and the lifting wheel 103 may be lowered.

For example, in the moving module 150, the first moving gear 153 may operate based on the operation of the moving drive source 151. As the first moving gear 153 is operated by the moving drive source 151, the second moving gear 155 may operate.

For example, as the first moving gear 153 rotates, the pinion gear 155a may rotate, and as the pinion gear 155a rotates, the rack gear 155b may move linearly. The rack gear 155b may apply a force to the driving wheel module 110 to allow the driving wheel 101 to move toward the inside of the housing 10. For example, the rack gear 155b may push the case support portion 111c of the driving wheel module 110 to allow the driving wheel module 110 to rotate relative to the wheel cover 104 in a direction in which the driving wheel 101 is raised. As the driving wheel module 110 rotates relative to the wheel cover 104 in the direction in which the driving wheel 101 is raised, the elastic body 109 may be tensioned.

For example, as the first moving gear 153 rotates, the lifting wheel module 130 connected to the first moving gear 153 may rotate. The first moving gear 153 may transmit a rotational force to the lifting wheel module 130 through the case gear portion 131c of the lifting wheel module 130. The first moving gear 153 may apply a force to the lifting wheel module 130 to allow the lifting wheel 103 to move toward the outside of the housing 10. For example, the first moving gear 153 may rotate the lifting wheel module 130 to allow the lifting wheel module 130 to rotate relative to the wheel cover 104 in a direction in which the lifting wheel 103 is lowered.

The cleaner 1 according to one embodiment of the present disclosure may limit a range in which the driving wheel module 110 may rotate relative to the wheel cover 104 by the moving module 150 and the elastic body 109 of the driving device 100.

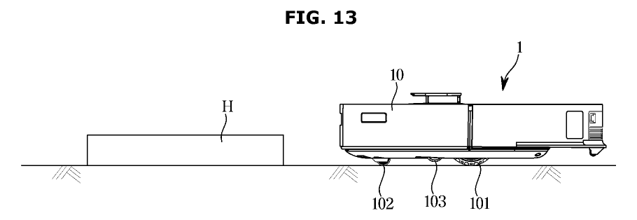

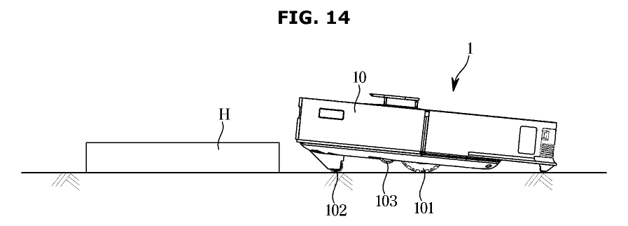

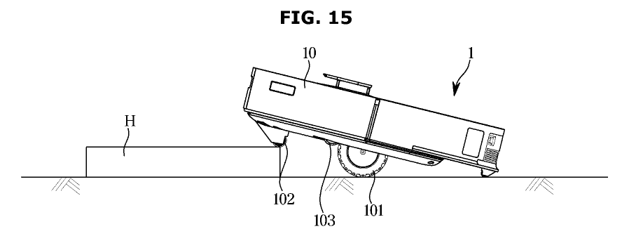

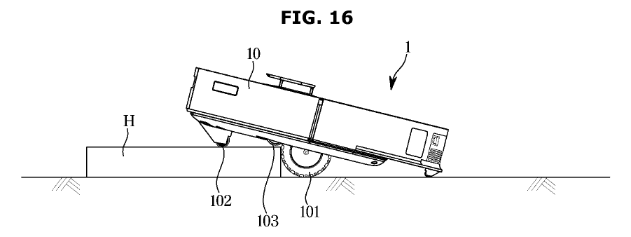

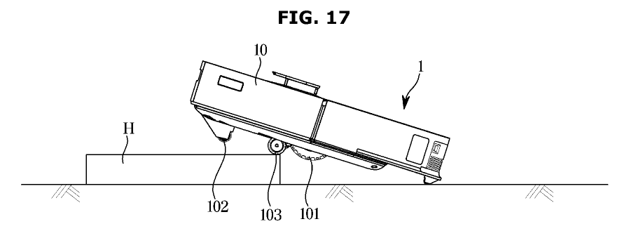

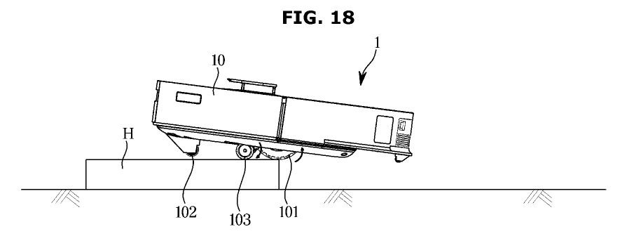

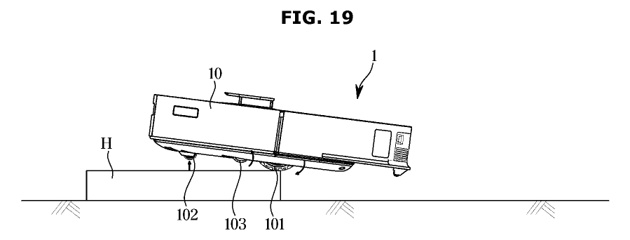

FIG. 13 illustrates a state in which the cleaner according to one embodiment of the present disclosure detects a height of an obstacle. FIG. 14 illustrates a state in which the cleaner according to one embodiment of the present disclosure approaches an obstacle and lowers a caster. FIG. 15 illustrates a state in which the caster of the cleaner according to one embodiment of the present disclosure climbs on the obstacle. FIG. 16 illustrates a state in which the driving wheel of the cleaner according to one embodiment of the present disclosure comes into contact with the obstacle. FIG. 17 illustrates a state in which the lifting wheel of the cleaner according to one embodiment of the present disclosure is lowered and the driving wheel is raised. FIG. 18 illustrates a state in which the driving wheel of the cleaner according to one embodiment of the present disclosure is placed on an obstacle. FIG. 19 illustrates a state in which the lifting wheel of the cleaner according to one embodiment of the present disclosure is raised and the driving wheel is lowered.

A process in which the cleaner 1 according to one embodiment of the present disclosure passes through an obstacle H having a height higher than a predetermined height is described with reference to FIGS. 13 to 19.

Referring to FIGS. 9 to 13, in the cleaner 1 according to one embodiment of the present disclosure, the moving module 150 of the driving device 100 may operate in the first mode while the cleaning is performed on a floor surface. While the moving module 150 operates in the first mode, the driving wheel 101 may move toward the outside of the housing 10 to descend, and the lifting wheel 103 may move toward the inside of the housing 10 to ascend. The driving device 100 may be in a state in which the elastic body 109 is tensioned by a predetermined length due to a load of the cleaner 1. As the elastic body 109 is tensioned by the predetermined length due to the load of the cleaner 1, the driving device 100 may be in a state in which the driving wheel module 110 rotates relative to the wheel cover 104 by a predetermined angle and the driving wheel 101 is moved by a predetermined distance toward the inside of the housing 10.

When the obstacle H is present in the driving direction, a height of the obstacle H may be determined. For example, the cleaner 1 may detect the presence of the obstacle H and the height of the obstacle H through the obstacle sensor 70.

Referring to FIG. 14, the cleaner 1 according to one embodiment of the present disclosure may approach the obstacle H and lower the caster 102 when the obstacle H is higher than a predetermined height.

Referring to FIG. 15, in the cleaner 1 according to one embodiment of the present disclosure, the caster 102 may climb up the obstacle H and a front end of the cleaner 1 may move to an upper side of the obstacle H.

For example, an operation of lowering the caster 102 and climbing up the obstacle H may be omitted.

Referring to FIG. 16, in the cleaner 1 according to one embodiment of the present disclosure, when the front end thereof moves forward by a predetermined distance on the obstacle H, the driving wheel 101 may come into contact with the obstacle H. For example, when the height of the obstacle H is greater than a radius of the driving wheel 101, the driving wheel 101 may be restricted from moving up the obstacle H.

Referring to FIG. 17, in the cleaner 1 according to one embodiment of the present disclosure, when the moving module 150 of the driving device 100 operates in the second mode, the driving wheel 101 may move toward the inside of the housing 10 and be raised, and the lifting wheel 103 may move toward the outside of the housing 10 and be lowered. As the lifting wheel 103 moves toward the outside of the housing 10 and is lowered, the lifting wheel 103 may be placed on the obstacle H. As the driving wheel 101 moves toward the inside of the housing 10 and is raised, the driving wheel 101 may be separated from the floor surface.

Referring to FIG. 18, the cleaner 1 according to one embodiment of the present disclosure may move forward as the lifting wheel 103 operates while the lifting wheel 103 is placed on the obstacle H. When the cleaner 1 moves forward by a predetermined distance by operating the lifting wheel 103, the driving wheel 101 may be placed on the obstacle H.

Referring to FIG. 19, in the cleaner 1 according to one embodiment of the present disclosure, when the driving wheel 101 is placed on the obstacle H, the moving module 150 may operate in the first mode. As the moving module 150 operates in the first mode, the lifting wheel 103 may move toward the inside of the housing 10 and be raised, and the driving wheel 101 may move toward the outside of the housing 10 and be lowered. The cleaner 1 may move forward on the obstacle H by operating of the driving wheel 101.

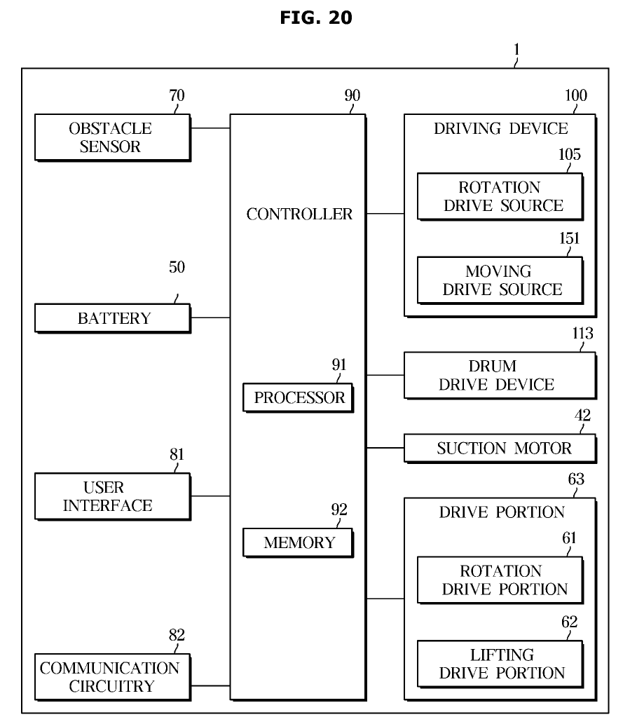

FIG. 20 illustrates a control block diagram of the cleaner according to one embodiment of the present disclosure.

Referring to FIG. 20, the cleaner 1 according to one embodiment may include the obstacle sensor 70, a liquid sensor 71, the battery 50, a user interface 81, the driving device 100, a drum drive device 113, the suction motor 42, a communication circuitry 82, and/or the controller 90.

The obstacle sensor 70 detects an obstacle that interferes with the driving of the cleaner 1. The obstacle may mean any object that protrudes from a floor of a cleaning region and interferes with the driving of the cleaner 1. For example, not only a table or sofa located in the cleaning region, but also a wall dividing the space may be the obstacle, and an object such as a threshold or a round bar that the cleaner 1 may climb up and down may also be the obstacle.

Particularly, the obstacle sensor 70 may detect an obstacle in a non-contact manner using electromagnetic waves such as infrared rays, visible light, or ultrasonic waves. For example, the obstacle sensor 70 may detect infrared rays reflected from an obstacle after emitting infrared rays, and output an intensity of the detected infrared rays, or a time interval (Time Of Flight: TOF), in which the reflected infrared rays are detected after emitting infrared rays, to the controller 90.

The controller 90 may calculate the presence or absence of the obstacle or a distance between the obstacle and the cleaner 1 based on an output value of the obstacle sensor 70.

As another example, the obstacle sensor 70 may include a transmitter configured to detect electromagnetic waves, and a receiver configured to receive electromagnetic waves reflected from the obstacle.

The transmitter may be disposed in the front portion of the housing 10 and transmit electromagnetic waves toward the front of the housing 10. In addition, according to embodiments, the transmitter may include a light emitting diode (LED) configured to generate electromagnetic waves and a wide-angle lens provided to refract the transmitted electromagnetic waves to spread the electromagnetic waves in all directions.

As another example, the obstacle sensor 70 may include a camera configured to obtain images of the vicinity (for example, front side, rear side and/or lateral side) of the cleaner 1.

The controller 90 may calculate the presence or absence of an obstacle or a distance between the obstacle and the cleaner 1 based on the image obtained by the obstacle sensor 70.

The battery 50 may supply power to various electrical components of the cleaner 1. The battery 50 may be charged while the cleaner 1 is docked to the station.

The cleaner 1 may include a battery sensor configured to detect a charge amount of the battery 50.

The controller 90 may control a driving device 100 to allow the cleaner 1 to return to the station when the charge amount of the battery 50 falls to a predetermined charge amount or less.

The user interface 81 may include an output interface and an input interface.

At least one output interface may transmit various information related to the operation of the cleaner 1 to a user by generating sensory information.

For example, the at least one output interface may transmit information related to settings of the cleaner 1 and an operating time of the cleaner 1 to a user. The information related to the operation of the cleaner 1 may be output by a display, an indicator, and/or a voice. The at least one output interface may include a liquid crystal display (LCD) panel, an indicator, a light emitting diode (LED) panel, a speaker, and the like.

When the display includes a touch screen display, the touch screen display may be an example of the output interface and the input interface.

According to one embodiment, the at least one output interface may output sensory information (for example, visual information, auditory information, and the like) related to the control of the cleaner 1.

The at least one input interface may convert sensory information received from a user into an electrical signal.

The at least one input interface may include a power button for turning on the cleaner 1.

Each button may include a visual indicator (for example, text, an icon, and the like) provided to indicate a function thereof.

The at least one input interface may include a tact switch, a push switch, a slide switch, a toggle switch, a microswitch, a touch switch, a touch pad, a touch screen, a jog dial, and/or a microphone.

In the present disclosure, 'button' may be replaced with a User Interface (UI) element, a tact switch, a push switch, a slide switch, a toggle switch, a micro switch, a touch switch, a touch pad, a touch screen, a jog dial, and/or a microphone.

The cleaner 1 may process user input received through the user interface 81 and output information related to the cleaner 1 through the user interface 81.

According to one embodiment, the user interface 81 may include an input interface for receiving a mop cleaning command and/or a mop steam command.

When a user determines that the mop 60 of the cleaner 1 needs to be cleaned or sterilized, the user can input the mop cleaning command and/or the mop steam command through the input interface.

The cleaner 1 may return to the station when the mop cleaning command and/or the mop steam command is received through the input interface.

When the mop cleaning command and/or the mop steam command is input through the input interface, the cleaner 1 may transmit a mop cleaning request signal and/or a mop steam request signal to the station.

Accordingly, when the cleaner 1 returns to the station and is docked to the station, the station may perform a washing cycle (for example, a cleaning cycle and/or a steam cycle).

The driving device 100 may include the rotation drive source 105 for supplying the rotational force to the driving wheel 101 and/or the lifting wheel 103, and the moving drive source 151 for moving the driving wheel module 110 and/or the lifting wheel module 130.

The driving wheel 101 may move the housing 10 by rotation. The housing 10 may be moved forward, backward, or rotated by rotation of the driving wheel 101. For example, when both the left and right main wheels 101 are rotated forward, the housing 10 may be moved straight forward, and when both the left and right main wheels 101 are rotated backward, the housing 10 may be moved straight backward.

In addition, when the left and right main wheels 101 are rotated in the same direction but at different speeds, the housing 10 may curve to the right or left side. When the left and right main wheels 101 are rotated in different directions, the housing 10 may be rotated to the left or right side in place.

The wheel motor generates a rotational force to rotate the driving wheels 101. A direct current (DC) motor or a brushless direct current (BLDC) motor may be employed as the wheel motor, but there is no limitation in the type of wheel motor in one embodiment of the cleaner 1.

The wheel motors may include a left wheel motor configured to rotate the left driving wheel, and a right wheel motor configured to rotate the right driving wheel.

Each of the left and right wheel motors may operate independently according to a control signal from the controller 90, and the housing 10 may be moved forward, backward, or rotated according to the operation of the left and right wheel motors.

The controller 90 may control the movement of the cleaner 1 by controlling the driving device 100 (for example, wheel motor).

The drum drive device 113 may rotate the drum 22.

The controller 90 may control the drum drive device 113 to rotate the drum 22 during dry cleaning, thereby allowing foreign substances on the floor to be scattered away by the drum 22.

The suction motor 42 may draw foreign substances scattered by the drum 22 into the dust collector 40 and may rotate a suction fan configured to generate a suction force to draw the foreign substances into the dust collector 40.

The controller 90 may control the suction motor 42 to rotate the suction fan during the dry cleaning, thereby allowing foreign substances scattered by the drum 22 to be introduced into the dust collector 40 through the suction port 11.

The controller 90 may control an intensity of the suction motor 42. The intensity of the suction motor 42 may correspond to a rotation speed of the suction motor 42 and/or a duty ratio of the suction motor 42.

A drive portion 63 may include a rotation drive portion 61 configured to rotate the mop 60 and/or a lifting drive portion 62 configured to raise or lower the mop 60.

The controller 90 may rotate the mop 60 by controlling the rotation drive portion 61. The rotation drive portion 61 may include a motor for rotating the mop 60, and a drive circuit for driving the motor.

The controller 90 may raise or lower the mop 60 by controlling the lifting drive portion 62. That is, the controller 90 may move the mop 60 by controlling the lifting drive portion 62. The lifting drive portion 62 may include an actuator configured to move the mop 60.

The communication circuitry 82 may communicate with an external device (for example, a server, a user device, and a station) via wires and/or wirelessly.

The communication circuitry 82 may transmit data to an external device (for example, a server, a user device, and a station), or receive data from the external device. For the communication, the communication circuitry 82 may establish a direct (for example, wired) communication channel or a wireless communication channel between external devices, and support the performance of the communication through the established communication channel. According to one embodiment, the communication circuitry 82 may include a wireless communication module (for example, a cellular communication module, a short-range wireless communication module, or a global navigation satellite system (GNSS) communication module) or a wired communication module (for example, a local area network (LAN) communication module, or a power line communication module). Among these communication modules, the corresponding communication module may communicate with an external device through a first network (for example, a short-range wireless communication network such as Bluetooth, wireless fidelity (Wi-Fi) direct, or infrared data association (IrDA)) or a second network (for example, a long-range wireless communication network such as a legacy cellular network, a 5G network, a next-generation communication network, the Internet, or a computer network (for example, LAN or WAN). These various types of communication modules may be integrated as one component (for example, a single chip) or implemented as a plurality of separate components (for example, multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, and the like, but is not limited thereto.

The long-range wireless communication module may include a communication module that performs various types of long-range wireless communication, and may include a mobile communication interface. The mobile communication interface transmits and receives radio signals with at least one of a base station, an external terminal, and a server on a mobile communication network.

According to one embodiment, the communication circuitry 82 may communicate with an external device through an access point (AP). The access point (AP) may connect a local area network (LAN), to which the cleaner 1 is connected, to a wide area network (WAN) to which a server is connected. The cleaner 1 may be connected to the server through the wide area network (WAN).

According to one embodiment, the communication circuitry 82 may communicate wirelessly with the station.

The controller 90 may control the overall operation of the cleaner 1.

The controller 90 may include at least one processor 91 configured to control the operation of the cleaner 1, and at least one memory 92 in which a program and data for controlling the operation of the cleaner 1 are stored.

The at least one processor 91 controls the overall operation of the cleaner 1. Particularly, the at least one processor 91 may be connected to each component of the cleaner 1 and may control the overall operation of the cleaner 1. For example, the at least one processor 91 may be electrically connected to the memory 92 and may control the overall operation of the cleaner 1. The processor 91 may be composed of one or more processors.

The at least one processor 91 may perform operations of the cleaner 1 according to various embodiments by executing at least one instruction stored in the memory 92.

The at least one memory 92 may store data required for various embodiments. The memory 92 may be implemented in the form of a memory embedded in the cleaner 1 or in the form of a memory detachable from the cleaner 1 depending on the purpose of data storage. For example, data for operating the cleaner 1 may be stored in a memory embedded in the cleaner 1, and data for an extended function of the cleaner 1 may be stored in a memory detachable from the cleaner 1. Meanwhile, the memory embedded in the cleaner 1 may be implemented as at least one of volatile memory (for example, dynamic RAM (DRAM), static RAM (SRAM), or synchronous dynamic RAM (SDRAM)), and non-volatile memory (for example, one time programmable ROM (OTPROM), programmable ROM (PROM), erasable and programmable ROM (EPROM), electrically erasable and programmable ROM (EEPROM), mask ROM, flash ROM, flash memory (for example, NAND flash or NOR flash), hard drive, or solid state drive (SSD)). In addition, the memory detachable from the cleaner 1 may be implemented in the form of a memory card (for example, compact flash (CF), secure digital (SD), micro secure digital (Micro-SD), mini secure digital (Mini-SD), extreme digital (xD), multi-media card (MMC)), external memory connectable to a USB port (for example, USB memory), and the like.

The at least one processor 91 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The at least one processor 91 may control one or any combination of other components of the cleaner 1, and may perform operations related to communication or data processing. The at least one processor 91 may execute at least one program or instruction stored in the memory 92. For example, the at least one processor 91 may perform a method according to at least one embodiment of the present disclosure by executing at least one instruction stored in the memory 92.

According to one embodiment, the controller 90 may control the drive portion 63 according to a predetermined condition. Controlling the drive portion 63 may include rotating or moving the mop 60. Moving the mop 60 may include raising or lowering the mop 60.

According to one embodiment, the controller 90 may control the drum drive device 113 and/or the suction motor 42 according to a predetermined condition.

According to one embodiment, the controller 90 may control the driving device 100 according to a predetermined condition. Controlling the driving device 100 may include moving the cleaner 1.

According to one embodiment, the controller 90 may control the moving drive source 151 of the driving device 100 according to a predetermined condition. Controlling the moving drive source 151 may include lifting the driving wheel 101 toward the inside of the housing 10 and lowering the lifting wheel 103 toward the outside of the housing 10. Controlling the moving drive source 151 may include lowering the driving wheel 101 toward the outside of the housing 10 and lifting the lifting wheel 103 toward the inside of the housing 10.

For example, when the cleaner 1 drives on the floor surface, the controller 90 may control the moving drive source 151 to raise the lifting wheel 103 and to lower the driving wheel 101.

For example, based on the height of the obstacle detected by the obstacle sensor 70 being higher than a predetermined height, the controller 90 may control the moving drive source 151 to lower the lifting wheel 103 and to raise the driving wheel 101.

A cleaner according to an embodiment includes a housing; and a driving device configured to move the housing. The driving device includes a driving wheel module including a driving wheel that is movable relative to the housing in a first direction toward an inside of the housing and in a second direction toward an outside of the housing; a lifting wheel module including a lifting wheel that is movable relative to the housing in the first direction and the second direction; and a moving module operable to: in a first mode, move the lifting wheel in the first direction toward the inside of the housing, and move the driving wheel in the second direction toward the outside of the housing, and in a second mode move the lifting wheel in the second direction toward the outside of the housing, and move the driving wheel in the first direction toward the inside of the housing.

The moving module may include a moving drive source configured to provide power to move the driving wheel and the lifting wheel according to the first mode and the second mode, a first moving gear connected to the moving drive source and configured to apply a force to the lifting wheel module to move the lifting wheel in the first direction and the second direction, and a second moving gear configured to apply a force to the driving wheel module to move the driving wheel in the first direction and the second direction based on the operation of the first moving gear.

The driving wheel module may further include a driving wheel case including a case support portion. With the moving module operated in the second mode, the case support portion may be supported by the second moving gear.

The lifting wheel module may further include a lifting wheel case including a case gear portion connected to the first moving gear.

The second moving gear may include a pinion gear and a rack gear.

The second moving gear may further include a moving support portion including a curved surface configured to contact a portion of the driving wheel module such that, with the moving module operated in the second mode, the driving wheel is restricted from moving in the second direction.

The driving device may further include a rotation drive source configured to generate power to rotate the driving wheel and the lifting wheel.

The driving device may further include a power transmission gear to transmit the power generated by the rotation drive source to the lifting wheel module to rotate the lifting wheel.

The lifting wheel module may further include a lifting wheel gear connected to the power transmission gear so as to receive the power generated by the rotation drive source, and a lifting transmission gear to transmit the power received by the lifting wheel gear to the lifting wheel to rotate the lifting wheel.

The driving wheel module may further include a driving wheel gear connected to the lifting wheel gear so as to receive the power generated by the rotation drive source, and a driving transmission gear to transmit the power received by the driving wheel gear to the driving wheel to rotate the driving wheel.

The driving device may further include a shaft configured to support the power transmission gear, the lifting wheel gear, and the driving wheel gear such that the power transmission gear, the lifting wheel gear, and the driving wheel gear are rotatable about the shaft, and the lifting wheel module and the driving wheel module may be rotatable around the shaft based on the operation of the moving module.

The driving device may further include an elastic body configured to apply an elastic force to the driving wheel module such that, with the moving module operated in the first mode, the driving wheel is moved in the second direction.

With the moving module operated in the first mode and with a force greater than the elastic force applied to the driving wheel module, the driving wheel may be moved in the first direction.

The driving device may further include a wheel cover on which the driving wheel module and the lifting wheel module are rotatably mounted. The elastic body may include a first end connected to the driving wheel module and a second end opposite the first end, and connected to the wheel cover.

The lifting wheel may be in front of the driving wheel with respect to a driving direction of the housing in which the driving device is configured to move the housing.

A cleaner according to one embodiment may include a housing; and a driving device configured to move the housing. The driving device may include: a driving wheel module including a driving wheel movable relative to the housing; a lifting wheel module including a lifting wheel movable relative to the housing; a rotation drive source configured to provide power for rotating the driving wheel and the lifting wheel; and a moving drive source configured to provide power for moving the driving wheel and the lifting wheel.

The cleaner may further include a first moving gear connected to the moving drive source, a second moving gear configured to apply a force to the driving wheel module to move the driving wheel based on the operation of the first moving gear, and a third moving gear configured to apply a force to the lifting wheel module to move the lifting wheel based on the operation of the first moving gear.

The driving device may include a power transmission gear for transmitting power generated from the rotation drive source to the lifting wheel module. The lifting wheel module may include a lifting wheel gear connected to the power transmission gear so as to receive power generated from the rotation drive source. The driving wheel module may include a driving wheel gear connected to the lifting wheel gear so as to receive power generated from the rotation drive source.

The driving device may include a shaft configured to rotatably support the power transmission gear, the lifting wheel gear, and the driving wheel gear. The lifting wheel module and the driving wheel module may be rotatable around the shaft based on the operation of the moving drive source.

The driving device may include an elastic body for applying an elastic force to the driving wheel module to allow the driving wheel to move toward an outside of the housing.

As is apparent from the above description, a cleaner may climb over an obstacle having a relatively high height by using a lifting wheel, and thus mobility performance of the cleaner may be improved.

Additional aspects of the disclosure will be set forth in part in the description which follows and, in part, will be obvious from the description, or may be learned by practice of the disclosure.

While the present disclosure has been particularly described with reference to exemplary embodiments, it should be understood by those of skilled in the art that various changes in form and details may be made without departing from the spirit and scope of the present disclosure.

1. A cleaner comprising:
a housing; and
a driving device configured to move the housing, the driving device including:
a driving wheel module including a driving wheel that is movable relative to the housing in a first direction toward an inside of the housing and in a second direction toward an outside of the housing;
a lifting wheel module including a lifting wheel that is movable relative to the housing in the first direction and the second direction; and
a moving module operable to:
in a first mode,
move the lifting wheel in the first direction toward the inside of the housing, and
move the driving wheel in the second direction toward the outside of the housing, and
in a second mode,
move the lifting wheel in the second direction toward the outside of the housing, and
move the driving wheel in the first direction toward the inside of the housing.

2. The cleaner of claim 1, wherein
the moving module includes:
a moving drive source configured to provide power to move the driving wheel and the lifting wheel according to the first mode and the second mode,
a first moving gear connected to the moving drive source and configured to apply a force to the lifting wheel module to move the lifting wheel in the first direction and the second direction, and
a second moving gear configured to apply a force to the driving wheel module to move the driving wheel in the first direction and the second direction based on the operation of the first moving gear.

3. The cleaner of claim 2, wherein
the driving wheel module further includes a driving wheel case including a case support portion, and
with the moving module operated in the second mode, the case support portion is supported by the second moving gear.

4. The cleaner of claim 2, wherein
the lifting wheel module further includes a lifting wheel case including a case gear portion connected to the first moving gear.

5. The cleaner of claim 2, wherein
the second moving gear includes a pinion gear and a rack gear.

6. The cleaner of claim 5, wherein
the second moving gear further includes a moving support portion including a curved surface configured to contact a portion of the driving wheel module such that, with the moving module operated in the second mode, the driving wheel is restricted from moving in the second direction.

7. The cleaner of claim 1, wherein
the driving device further includes a rotation drive source configured to generate power to rotate the driving wheel and the lifting wheel.

8. The cleaner of claim 7, wherein
the driving device further includes a power transmission gear to transmit the power generated by the rotation drive source to the lifting wheel module to rotate the lifting wheel.

9. The cleaner of claim 8, wherein
the lifting wheel module further includes:
a lifting wheel gear connected to the power transmission gear so as to receive the power generated by the rotation drive source, and
a lifting transmission gear to transmit the power received by the lifting wheel gear to the lifting wheel to rotate the lifting wheel.

10. The cleaner of claim 9, wherein
the driving wheel module further includes:
a driving wheel gear connected to the lifting wheel gear so as to receive the power generated by the rotation drive source, and
a driving transmission gear to transmit the power received by the driving wheel gear to the driving wheel to rotate the driving wheel.

11. The cleaner of claim 10, wherein
the driving device further includes a shaft configured to support the power transmission gear, the lifting wheel gear, and the driving wheel gear such that the power transmission gear, the lifting wheel gear, and the driving wheel gear are rotatable about the shaft, and
the lifting wheel module and the driving wheel module are rotatable around the shaft based on the operation of the moving module.

12. The cleaner of claim 1, wherein
the driving device further includes an elastic body configured to apply an elastic force to the driving wheel module such that, with the moving module operated in the first mode, the driving wheel is moved in the second direction.

13. The cleaner of claim 12, wherein
with the moving module operated in the first mode and with a force greater than the elastic force applied to the driving wheel module, the driving wheel is moved in the first direction.

14. The cleaner of claim 12, wherein
the driving device further includes a wheel cover on which the driving wheel module and the lifting wheel module are rotatably mounted, and
the elastic body includes:
a first end connected to the driving wheel module, and
a second end opposite the first end, and connected to the wheel cover.

15. The cleaner of claim 1, wherein
the lifting wheel is in front of the driving wheel with respect to a driving direction of the housing in which the driving device is configured to move the housing.
